(19) United States
(12) Patent Application Publication
(10) Pub. No.: US 2026/0347157 A1
(43) Pub. Date: Nov. 5, 2026

(54) LIFT CONSTRUCTION KIT AND LIFT

(71) Applicant: Nussbaum Automotive Lifts GmbH, Kehl- Bodersweier (DE)

(72) Inventors: Michael HIMMELSBACH, Seelbach (DE); Ludwig HUBER, Willstätt (DE)

(73) Assignee: Nussbaum Automotive Lifts GmbH, Kehl- Bodersweier (DE)

(21) Appl. No.: 19/105,074

(22) PCT Filed: Sep. 7, 2023
(86) PCT No.: PCT/EP2023/074603

§ 371 Date: Feb. 20, 2025

(30) Foreign Application Priority Data
Sep. 12, 2022 (DE) 20 2022 105 128.3

(51) Int. Cl. B66F 7/28

(52) U.S. Cl. CPC B66F 7/28

(57) ABSTRACT

A lift construction kit (1) with at least one lifting column (2) and a cross beam (4), in which the lifting column (2) has a first bearing element (5) in a head region, and in which the cross beam (4) has a second bearing element (6) in an end region. The first bearing element (5) and the second bearing element (6) are configured such that they can be connected, in order to configure, in a connected state 85, a pivot bearing (7), by which the cross beam (4) is mounted pivotably with respect to the lifting column (2).

### CROSS-REFERENCE TO RELATED APPLICATIONS

This application is a 371 National Phase pf PCT/EP 2023/074603, filed Sep. 7, 2023, which claims priority from German Patent Application No. 20 2022 105 128.3, filed Sep. 12, 2022, both of which are incorporated herein by reference as if fully set forth.

### TECHNICAL FIELD

The invention relates to a lift construction kit and to a lift.

### BACKGROUND

Lifts of the type mentioned at the outset serve to raise and position loads. In the embodiment as vehicle lifts, the loads are vehicles which can be moved into an adjustable height for repair and maintenance purposes and can subsequently be lowered again. Due to the installation space, it has proven effective to configure vehicle lifts with two lifting columns which are each provided with a hydraulic assembly and along which in each case at least one support arm is guided in a hydraulically adjustable manner. The support arms serve to receive the vehicle.

The two hydraulic assemblies of a lift of this type can be supplied with hydraulic fluid by means of a common hydraulic source in order to reduce costs. Here, the two hydraulic assemblies are operated with a uniform hydraulic pressure, which can lead in the case of an inhomogeneous load distribution, however, to the hydraulic assemblies being adjusted with different lift travels in an undesired way. In order to avoid this, it has proved effective to bring about a synchronization between the hydraulic assemblies by the latter being coupled mechanically by means of at least one cable or chain. For this purpose, the cable or the chain is guided between the lifting columns by means of a cross beam which is arranged at an upper end of the lift and connects the lifting columns to one another.

The arrangement of the cross beam between the lifting columns makes the installation and the dismantling of the lift more difficult. In the case of lifts which have a great overall height, in particular, two installers are usually required in order to be able to lift the cross beam homogeneously during installation and to connect it to the lifting columns. The dismantling of the lift is likewise of complex design, in which two installers are likewise required, in order to be able to initially release the cross beam from the lifting columns and to remove it safely.

### SUMMARY

It is an object of the invention to reduce the complexity during the installation and the dismantling of lifts with a cross beam.

The object is achieved by a lift construction kit having one or more of the features described herein and a lift also having one or more of the features described herein. Advantageous developments are provided in the following description and claims.

The lift construction kit according to the invention comprises at least one lifting column and a cross beam. The lifting column has a first bearing element in a head region. The cross beam has a second bearing element in an end region. The first bearing element and the second bearing element are configured such that they can be connected in such a way that the first bearing element and the second bearing element configure, in a connected state, a pivot bearing, by means of which the cross beam is mounted pivotably with respect to the lifting column.

One advantage of the lift construction kit according to the invention consists in that the cross beam can be arranged for installation purposes in a first installation step by way of a connection of the first and the second bearing element on the lifting column. In a subsequent second installation step, the cross beam can be pivoted from the lifting column, in order to be connected to another lifting column if required. As a result of these steps being performed sequentially, merely one installer is required even when lifts of great overall height are erected. Dismantling of the lift can likewise take place simply, by the cross beam initially being released from one of the lifting columns and being moved by means of the pivot bearing into a position, in which it can be handled by an installer.

The lift construction kit preferably comprises two lifting columns, wherein at least one first lifting column has the first bearing element in a head region. The cross beam has the second bearing element in an end region. The first bearing element and the second bearing element are configured such that they can be connected in such a way that the first bearing element and the second bearing element configure, in the connected state, the pivot bearing, by means of which the cross beam is mounted pivotably with respect to the first lifting column and can be arranged on a head region of the second lifting column by way of a pivoting movement.

In one advantageous development, the pivot bearing defines a first pivot axis which is oriented orthogonally with respect to a direction of extent of the lifting column, in particular of the first lifting column.

The configuration of the pivot bearing with the first pivot axis permits defined guidance of the cross beam during the pivoting movement. In particular, the first pivot axis can be oriented here orthogonally with respect to a plane which is defined by the two lifting columns of the lift to be erected. It is therefore possible here by means of the pivot bearing to pivot the cross beam from the lifting column, in particular the first lifting column, in the direction of the second lifting column, and to fasten the cross beam releasably to the latter, for example by means of a screw connection.

In one advantageous development, the pivot bearing defines a second pivot axis which is oriented orthogonally with respect to the first pivot axis and orthogonally with respect to the direction of extent of the lifting column, in particular of the first lifting column.

The configuration of the pivot bearing with two pivot axes is associated with a high freedom of movement during the assembly of the lift. In particular, two lifting columns can be moved, before the arrangement of the cross beam, into the positions, in which they are situated during subsequent operation of the lift. In order to arrange the cross beam, the latter can be initially pivoted by means of the pivot bearing about the first pivot axis from the first lifting column in the direction of the respective other, second lifting column. In order to avoid a collision of the cross beam with the second lifting column, the cross beam can be pivoted about the second pivot axis which is oriented orthogonally with respect to the first pivot axis and with respect to the direction of extent of the first lifting column. As a result, the cross beam is pivoted out of a plane which is defined by the directions of extent of the two lifting columns. After the cross beam has been guided past the lifting column, it can be arranged in a head region of the second lifting column and can be fastened releasably.

In one advantageous development, the first bearing element comprises a bearing eyelet, and the second bearing element comprises a hook element. The hook element can be mounted in the bearing eyelet, in order to configure the pivot bearing. As an alternative, the first bearing element can comprise the hook element, and the second bearing element can comprise the bearing eyelet. The bearing eyelet can be mounted in the hook element, in order to configure the pivot bearing.

By means of the above-described development, the cross beam can be mounted by means of the hook element on the bearing eyelet of the lifting column, in particular of the first lifting column, and is mounted movably here with respect to the lifting column with configuration of the pivot bearing. As an alternative, the cross beam can be mounted by means of the bearing eyelet on the hook element of the lifting column, in particular of the first lifting column, and is mounted movably here with respect to the lifting column with configuration of the pivot bearing.

The bearing eyelet comprises an opening which is preferably enclosed on the edge side and can be of integral configuration on the cross beam or on the lifting column, in particular the first lifting column. The bearing eyelet can likewise be configured with the opening as one component which is fastened to the cross beam or the lifting column, in particular the first lifting column. The hook element is a mechanical element which protrudes from the cross beam or lifting column and the geometry of which is selected in such a way as to engage into the bearing eyelet. In one embodiment, in which the hook element is configured or arranged on the lifting column, the hook element faces away from a base plate of the lifting column at least in regions.

The configuration of the pivot bearing is particularly simple by means of the bearing eyelet and the hook element, since an installer can orient the cross beam substantially parallel to the lifting column, in particular the first lifting column, and can join the hook element into the bearing eyelet, in order to mount the cross beam on the lifting column. The rigidity and/or the strength of the bearing eyelet and the hook element are/is preferably selected in such a way that the cross beam can be held without additional support means on the lifting column, in particular the first lifting column. In this way, the installer can release the cross beam as required after the configuration of the pivot bearing.

In one advantageous development, the hook element is configured as a metal plate which is angled away from the cross beam or from the lifting column, in particular the first lifting column.

One advantage of the above-described development consists in that the hook element can be configured as a component which is connected integrally to the cross beam or to the lifting column. It is particularly advantageous if the cross beam or the lifting column is configured as a component with a thin-walled cross section. Here, a metal plate contour of the hook element can be made in a simple way by means of a laser cut in the cross beam or the lifting column. Subsequently, the metal plate can be angled away from the cross beam or the lifting column by means of bending along a bending edge. In particular, the bending can take place by means of a screwdriver. For this purpose, the latter can be inserted into a slot of the lasered metal plate contour, and the metal plate can be bent out of the cross beam or the lifting column by means of a lever movement of the screwdriver.

The shape of the metal plate is fundamentally not restricted to a certain geometry. In one advantageous development, however, the metal plate has a substantially triangular basic shape and engages with a tip into the bearing eyelet, in order to configure the pivot bearing.

It is possible by way of the triangular basic shape of the metal plate to allow the metal plate to engage into the bearing eyelet in such a way that the metal plate is in contact on two sides of the triangular shape with the peripheral edge of the bearing eyelet. Here, substantially two contact points between the metal plate and the bearing eyelet are configured, about which the metal plate can be tilted relative to the bearing eyelet in the case of a pivoting movement being carried out. The shape of the metal plate which tapers toward the tip at least partially defines the movement range for the metal plate in the bearing eyelet. The bearing eyelet preferably has a substantially rectangular peripheral edge which delimits the movement range of the metal plate in the bearing eyelet.

In one advantageous development, the bearing eyelet is configured integrally on a head plate of the lifting column, in particular of the first lifting column. The hook element is arranged on the cross beam.

According to the above-described development, the production of the bearing eyelet is simplified, since it can preferably be produced in the same method step, in which the outer contour of the head plate is also produced. In particular, the head plate is configured in such a way that it projects beyond the lifting column, in particular the first lifting column, in the region of the bearing eyelet.

In one advantageous development, the cross beam has a first beam portion and a second beam portion which can be adjusted relative to one another along a cross beam axis. In particular, the first beam portion encloses the second beam portion at least in regions, wherein the second beam portion is guided telescopically by means of the first beam portion.

By way of the configuration of the cross beam with the first and the second beam portion, the overall length of the cross beam can be changed in a simple way. This can be advantageous, in particular, when the cross beam is connected pivotably to the lifting column, in particular the first lifting column, and the surrounding conditions do not allow a free pivoting movement of the cross beam, in order to pivot the latter out of the plane which is defined by the two lifting columns. In a case of this type, the overall length of the cross beam can be shortened telescopically to a minimum. Subsequently, the pivoting movement can be carried out exclusively in the plane which is defined by the two lifting columns. As soon as the cross beam has been guided past the second lifting column, its overall length can be increased, in order to connect the cross beam in an end region to the second lifting column.

As mentioned above, the invention also relates to a lift. The lift according to the invention comprises a first lifting column, a second lifting column and a cross beam. The first lifting column and the second lifting column are arranged spaced apart in parallel with respect to one another, wherein at least the first or the second lifting column has a first bearing element in a head region, and wherein the cross beam has a second bearing element in an end region. The first bearing element and the second bearing element are connected to one another and configure a pivot bearing. The cross beam is connected releasably to the second lifting column on an end region which faces away from the pivot bearing.

The lift according to the invention preferably comprises the lift construction kit according to the invention or an advantageous development thereof. Therefore, the lift according to the invention is associated, in particular, with a low installation complexity. This is achieved by the construction kit according to the invention being provided and being assembled with configuration of the pivot bearing. Here, the cross beam is connected at least temporarily pivotably to the first lifting column and is pivoted away from the latter, in order to be connected to the second lifting column. Otherwise, the comments with respect to the advantages of the lift construction kit according to the invention and its advantageous developments apply correspondingly.

### BRIEF DESCRIPTION OF THE DRAWINGS

Further advantages of the invention are explained in the following text on the basis of one exemplary embodiment and the figures, in which:

FIG. 1 shows a lift construction kit with two lifting columns and a cross beam, wherein the cross beam is mounted on one of the lifting columns by means of a pivot bearing,

FIG. 2 shows a side view of the pivot bearing,

FIG. 3 shows the cross beam,

FIG. 4 shows a lift with a pivot bearing, and

FIG. 5 shows the pivot bearing of the lift.

### DETAILED DESCRIPTION

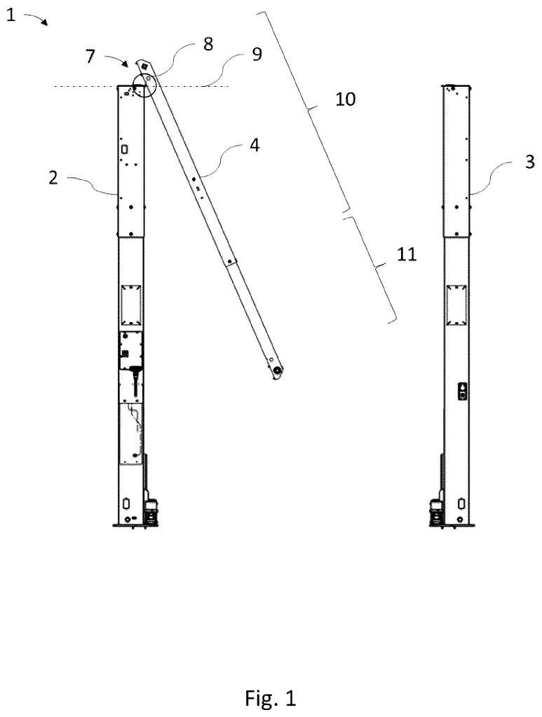

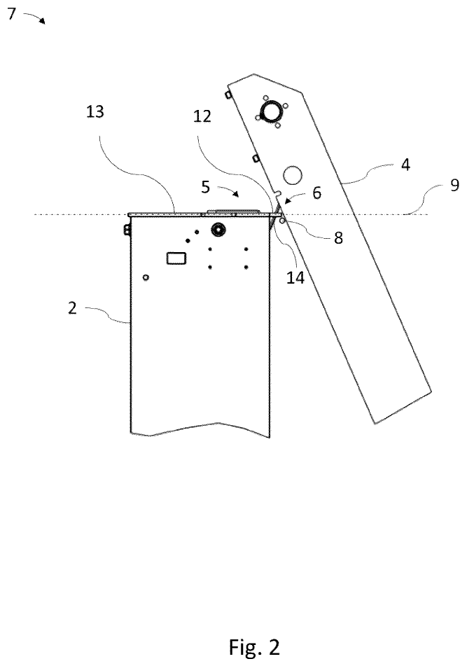

FIG. 1 shows a lift construction kit 1 with two lifting columns 2, 3 and a cross beam 4. A first lifting column 2 has a first bearing element 5 in a head region (cf. FIG. 2). The cross beam 4 has a second bearing element 6 in an end region (cf. FIG. 2). The first bearing element 5 (cf. FIG. 2) and the second bearing element 6 (cf. FIG. 2) are configured such that they can be connected to one another and, in a connected state which is shown in FIG. 1, configure a pivot bearing 7.

One advantage of the lift construction kit 1 shown in FIG. 1 is that the cross beam 4 can be arranged for installation purposes, in a first installation step, by connection of the first bearing element 5 (cf. FIG. 2) and the second bearing element 6 (cf. FIG. 2) on the first lifting column 2. In a subsequent second installation step, the cross beam 4 can be pivoted from the first lifting column 2, in order to be connected to the other, second lifting column 3. As a result of a sequential performance of these steps, merely one installer is required for erecting lifts. Dismantling of the lift can likewise take place simply, by the cross beam 4 initially being released from the second lifting column 3 and being moved by means of the pivot bearing 7 into a position, in which it can be handled by a single installer.

A further advantage of the lift construction kit 1 shown in FIG. 1 consists in that the pivot bearing 7 defines two pivot axes 8, 9, wherein a first pivot axis 8 runs according to FIG. 1 orthogonally with respect to the plane of the drawing, and a second pivot axis 9 runs parallel to the plane of the drawing. Moreover, the first pivot axis 8 and the second pivot axis 9 run orthogonally with respect to one another and with respect to the axis of extent of the first lifting column 2.

The configuration of the pivot bearing 7 with the two pivot axes 8, 9 is associated with a high freedom of movement during the installation of the lift. In particular, the two lifting columns 2, 3 can be moved, before the arrangement of the cross beam 4, into their final positions, in which they are situated during subsequent operation of the lift. In order to arrange the cross beam 4, the latter can be pivoted by means of the pivot bearing 7 initially about the first pivot axis 8 from the first lifting column 2 in the direction of the second lifting column 3. In order to avoid a collision of the cross beam 4 with the second lifting column 3 here, the cross beam 4 can be pivoted about the second pivot axis 9. In relation to FIG. 1, the cross beam 4 is pivoted here out of the plane of the drawing and can be guided past the second lifting column 3 and can be fastened releasably in the head region of the latter, for example by means of a screw connection.

The installation of the lift by means of the lift construction kit 1 is additionally simplified, since the cross beam 4 has a first beam portion 10 and a second beam portion 11 which can be adjusted relative to one another along a cross beam axis. Here, the first beam portion 10 encompasses the second beam portion 11 in such a way that the second beam portion 11 is guided telescopically by means of the first beam portion 10. As a result, it is possible for an overall length of the cross beam 4 to be shortened as required, as a result of which it can be handled more simply during the installation.

The construction of the pivot bearing 7 which is shown in FIG. 1 is explained in detail in the following text with reference to FIGS. 2, 3 and 4.

FIG. 2 shows a side view of the pivot bearing 7. The first bearing element 5 is configured as a bearing eyelet 12 which is connected integrally to a head plate 13 of the first lifting column 2 and projects laterally beyond the first lifting column 2. The second bearing element 6 is configured as a metal plate 14 which is connected in an integral and angled-away manner to the cross beam 4. The metal plate 14 engages into the bearing eyelet 12 in order to configure the pivot bearing 7. Here, for installation purposes, the cross beam 4 can be mounted into the first lifting column 2, as a result of which the installation by way of an installer is of particularly simple design.

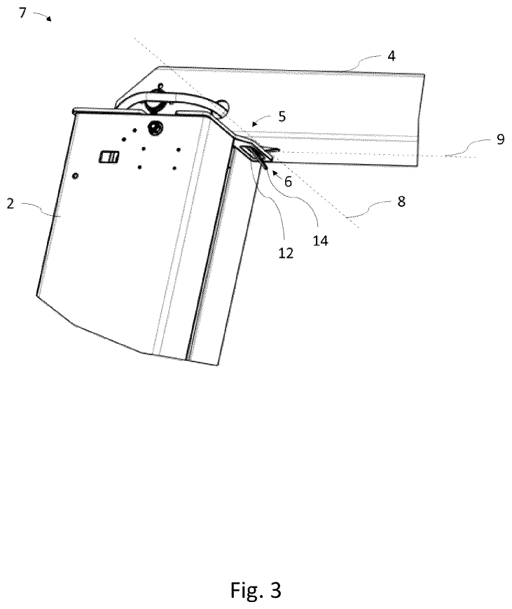

As is shown in FIG. 3, the bearing eyelet 12 has an opening with a substantially rectangular cross section, into which the metal plate 14 engages in order to configure the pivot bearing.

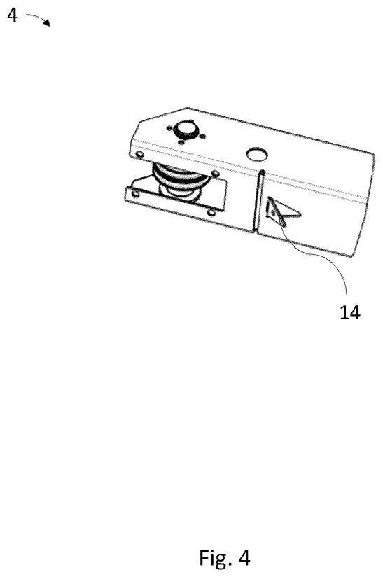

As can be seen on the basis of FIG. 4, the metal plate 14 has a substantially triangular shape and is connected on one side integrally to the cross beam 4. In order to configure the pivot bearing 7 (cf. FIGS. 1 to 3), the metal plate 14 engages with a tip into the bearing eyelet 12 and lies on the edge of the bearing eyelet 12. Two tilting points are produced as a result, in order that the cross beam 4 can be pivoted about the first pivot axis 8 and the second pivot axis 9.

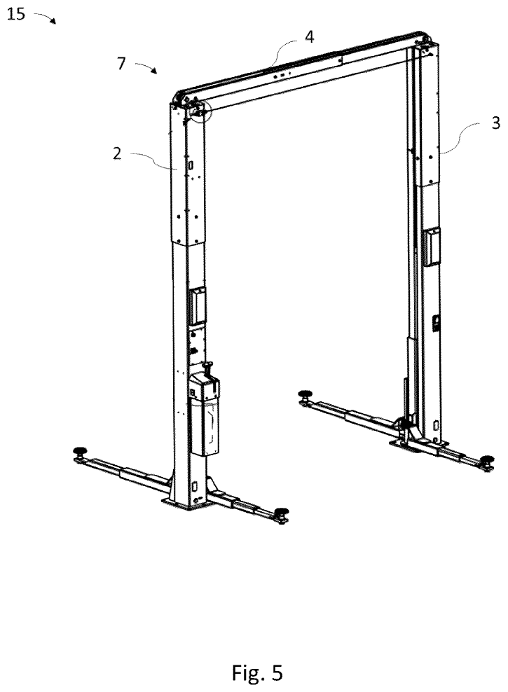

FIG. 5 shows a lift 15 which has been erected by installation of the lift construction kit 1. The lift 15 comprises the first lifting column 2, the second lifting column 3 and the cross beam 4. The first lifting column 2 and the second lifting column 3 are arranged spaced apart substantially parallel with respect to one another. In its head region, the first lifting column 2 has the first bearing element 5 (cf. FIGS. 1 to 3), and the cross beam 4 has the second bearing element 6 (cf. FIGS. 1 to 3). The first bearing element 5 (cf. FIGS. 1 to 3) and the second bearing element 6 (cf. FIGS. 1 to 3) are connected to one another and configure the pivot bearing 7. On an end region which faces away from the pivot bearing 7, the cross beam 4 is screwed releasably to the second lifting column 3.

1. A lift construction kit (1), comprising:
at least one lifting column (2),
the lifting column (2) has a first bearing element (5) in a head region,
a cross beam (4), the cross beam (4) has a second bearing element (6) in an end region, wherein
the first bearing element (5) and the second bearing element (6) are configured to be connectable in order to configure, in a connected state, a pivot bearing (7), by which the cross beam (4) is mounted pivotably with respect to the lifting column (2).

2. The lift construction kit (1) as claimed in claim 1, wherein
the pivot bearing (7) defines a first pivot axis (8) which is oriented orthogonally with respect to a direction of extent of the lifting column (2).

3. The lift construction kit (1) as claimed in claim 2, wherein
the pivot bearing (7) defines a second pivot axis (9) which is oriented orthogonally with respect to the first pivot axis (8) and orthogonally with respect to the direction of extent of the lifting column (2).

4. The lift construction kit (1) as claimed in claim 1, wherein
the first bearing element (5) comprises a bearing eyelet (12), and
the second bearing element (6) comprises a hook element (14), or
the first bearing element (5) comprises a hook element (14), and
the second bearing element (6) comprises a bearing eyelet (12),
wherein the bearing eyelet (2) and the hook element (14) are mountable in one another, in order to configure the pivot bearing (7).

5. The lift construction kit (1) as claimed in claim 4, wherein
the hook element (14) is configured as a metal plate which is angled away from the cross beam (4) or the lifting column (2).

6. The lift construction kit (1) as claimed in claim 5, wherein
the metal plate has a substantially triangular basic shape and engages with one tip into the bearing eyelet (12), in order to configure the pivot bearing (7).

7. The lift construction kit (1) as claimed in claim 4, wherein
the bearing eyelet (12) has a substantially rectangular peripheral edge which delimits a movement range of the hook element (14) in the bearing eyelet (12).

8. The lift construction kit (1) as claimed in claim 4, wherein
the bearing eyelet (12) is configured integrally on a head plate (13) of the lifting column (14), and the hook element (14) is arranged on the cross beam (4).

9. The lift construction kit (1) as claimed in claim 1, wherein
the cross beam (4) has a first beam portion (10) and a second beam portion (11) which are adjustable relative to one another along a cross beam axis.

10. The lift construction kit (1) as claimed in claim 9, wherein
the first beam portion (10) encloses the second beam portion (11) at least in regions, and the second beam portion (11) is guided telescopically by the first beam portion (10).

11. A lift (15), comprising:
a first lifting column (2),
a second lifting column (3), and
a cross beam (4),
wherein the first lifting column (2) and the second lifting column (3) are arranged spaced apart in parallel with respect to one another,
at least the first lifting column (2) has a first bearing element (5) in a head region,
the cross beam (4) has a second bearing element (6) in an end region,
the first bearing element (5) and the second bearing element (6) are connected to one another and configure a pivot bearing (7), and
the cross beam (4) is connected releasably to the second lifting column (3) on an end region which faces away from the pivot bearing (7).
